(19) United States
(12) Patent Application Publication
(10) Pub. No.: US 2008/0196033 A1
(43) Pub. Date: Aug. 14, 2008

(54) METHOD AND DEVICE FOR PROCESSING NETWORK DATA

(75) Inventor: JIN CHEN, Shenzhen (CN)

Correspondence Address: LADAS & PARRY LLP, 26 WEST 61ST STREET, NEW YORK, NY, 10023, US

(73) Assignee: HUA WEI TECHNOLOGIES CO., LTD

(21) Appl. No.: 11/840,430

(22) Filed: Aug. 17, 2007

(30) Foreign Application Priority Data
Aug. 18, 2006 (CN) 200610062218.5

(51) Int. Cl. G06F 9/50

(52) U.S. Cl. 718/103

(57) ABSTRACT

The invention discloses a method and a device for network data processing. The method includes: configuring a priority for at least one input port; preferentially switching the input data from the input port with a priority or a high priority according to the priority of the input port; and outputting the switched data. The network device includes a priority configuring module adapted to configure a priority or a high priority for an input port which has a narrow bandwidth or is comparatively important, a data switching module adapted to preferentially switch the input data from the precedence input ports, and an output module adapted to output the switched data. The invention is applicable in the network device containing important input ports for the purpose of enhancing the transmission rate and transmission quality of the data from the important input port.

### FIELD OF THE INVENTION

The invention relates to the field of network communication technology, in particular, to the network data processing technology.

### BACKGROUND OF THE INVENTION

Network devices such as switches, routers and gateways are usually used for the connections and interfaces between networks, such as between Local Area Networks (LANs), LAN and Wide Area Network (WAN) and so on, for implementing the data switching between a plurality of ports and switching the data arriving at an input port (e.g. packet or cell) to a corresponding output port. When there are a plurality of input ports for data input, in the network switching devices, the network switching resources are usually allocated with the following method for data processing: polling (a method for choosing a port from a group of ports by turns. Generally speaking, if port n was chosen last time, then port (n+d) is chosen this time, wherein d>0) each input port to receive data, and outputting the data in queue at each output port after forwarding and scheduling the data. In this way, the situation that a plurality of input ports compete against each other for an output port may occur, which may lead to data jam or loss.

FIG. 1 shows an existing network device 100, including:

an input module 101 adapted to poll each input port to ascertain whether data exists, if no data exists, skip the port, otherwise, receive the data;

a forwarding module 102 adapted to check the data or the data associated information, such as the destination address, source address, protocol, port number, data length or some fields in the data, and perform a predetermined processing for the data, obtain the forwarding information of the next hop of the data by checking a forwarding table or a routing table according to the information of the data; send the forwarding information of the data to a queuing and scheduling module.

the queuing and scheduling module 103 adapted to make the data queue up according to the result from the forwarding module, load the data from a certain queue and send the data or the information of the data (such as the address in a storage module) to an output module;

the output module 104 adapted to send the data to an output port for outputting according to the processing result from the queuing and scheduling module;

a storage module 105 adapted to store data and information.

The input module 101 in the prior art receives data from each input port by polling, however, an input port that is important or has a narrow bandwidth is liable to be impacted by the traffic from the input port having a broad bandwidth, so that the delay and increase of the packet loss rate of the data from an important input port or from an input port having a narrow bandwidth may be caused. During the implementation of the embodiments of the invention, it is found out by the applicant that the queuing and scheduling module 103 in the prior art performs queuing and scheduling according to the output port, but it neither puts the data from an important input port or from a port with a narrow bandwidth in a separate queue during queuing, nor is able to treat the data from such input port differently during scheduling, thus the delay and increase of the packet loss rate of the data from an important port or from a port with a narrow bandwidths may also be caused. Therefore, for the existing network device or system 100 adopting the solutions mentioned above, there is no difference between the input ports, and accordingly, the data flow from the input port having a narrow bandwidth is liable to be impacted by the data from other ports to cause a data jam. As a result, the data output quality of the important input port may not be guaranteed.

For example, in the broadband access network widely applied nowadays, the broadband access port is called WAN port, and other ports are called LAN ports. The WAN port bears the aggregation of all the traffics sent to or from an external network, which will be charged for use. However, the WAN port usually has an effective bandwidth which is much narrower than that of the LAN port, so data is transferred slowly. More seriously, since the traffic on the LAN side is relatively heavy, the WAN traffic may easily be impacted by the LAN traffic to cause a jam. In addition, since the WAN port traffic passes the external network, compared with the LAN traffic, the delay and packet loss of the WAN port traffic may be more serious. In the case of one of the applications—ADSL (Asymmetric Digital Subscriber Line) User Terminal, the bandwidth for ADSL to access the WAN port is mostly below 1.5 Mbps in practice, while for other LAN ports, the bandwidth is mostly 100 Mbps, so that when the traffic on the LAN side is relatively heavy, the traffic from the WAN port may be affected greatly, and as a result, the user connection speed and delay may be even worse.

Because of the prevalence of network connections and rapid development of real-time applications such as network audio, video and games, the QoS (Quality of Service) of the network, such as the effective bandwidth, delay and packet loss, etc., becomes more and more important. In particular, for the broadband access such as XDSL (X Digital Subscriber Line, generally referring to ADSL, ADSL2/2+ and VDSL, etc.) and Broadband Cable technology, the bandwidth is currently a bottleneck at large. Therefore, it has become a problem to be resolved urgently in practice to overcome the output jam of the data from an important input port, and avoid the impacts and interferences from other input ports.

### SUMMARY OF THE INVENTION

The embodiments of the invention provide a network device and a method for processing network data, with which the traffic of an input port that has a relatively narrow bandwidth or is relatively important may be guaranteed preferentially, so that the influence from other input ports may be eliminated, the transfer rate and transfer quality of the important input port and the input data may be increased, and the bandwidth utilization may be optimized.

Another embodiment of the invention provides a network access device which includes a WAN input port and a LAN input port. With the network access device, the transfer rate and quality of WAN port data may be increased by preferentially guaranteeing the traffic of the WAN port.

Still another embodiment of the invention provides a method for allocating network resources in a network system.

The objects of the invention are achieved by the following technical solutions:

A network device, including:

a data switching module having at least two input ports, wherein at least one of the input ports is configured with a priority, and the data switching module is adapted to perform data switching for input data from each input port according to the priority and send the data out; and

an output module, adapted to output the data processed by the data switching module.

A network access device, including:

a data switching module having at least one WAN input port and at least one LAN input port, wherein at least one input port is configured with a priority, the data switching module is adapted to perform data switching for input data from each input port according to the priority, and preferentially process data from the WAN input port with a priority or a comparatively high priority, and send the processed data to the output module; and

an output module adapted to output the data processed by the data switching module.

A method for network data processing, including:

performing data switching preferentially for input data from a precedence input port according to a preset priority of at least one input port; and

outputting switched data.

A method for network resource allocation in a network system, including:

determining a plan for allocation of all kinds of network resources according to a priority, and sending out priority control information; and

allocating all kinds of network resources according to the priority control information, so as to preferentially process input data with a priority or a high priority.

With compact and effective methods, the embodiments of the invention overcome the defects in the prior art that the data from the input port which has a relatively narrow bandwidth or is relatively important are liable to suffer from delay, packet loss, output jam and are liable to be impacted and interfered by other ports, etc., so as to improve the quality of service such as the data delay, packet loss rate and bandwidth utilization of the precedence port, and further to allocate the resources in a network device more reasonably. Moreover, the embodiments of the invention may also ensure the accomplishments and output qualities of key services under different conditions by flexible configuration according to requirements.

### BRIEF DESCRIPTION OF THE DRAWINGS

FIG. 1 is a functional diagram of the existing network device;

FIG. 2 is a functional diagram of the network device according to an embodiment of the invention;

FIG. 3 is a flow chart of the data processing method according to an embodiment of the invention;

FIG. 4 is a schematic diagram showing the principle for receiving input data according to a first preferred embodiment of the invention;

FIG. 5 is a flow chart of the reception of the input data according to the first embodiment of the invention;

FIG. 6 is a first schematic diagram showing the principle for queuing and scheduling according to a second embodiment of the invention;

FIG. 7 is a second schematic diagram showing the principle for queuing and scheduling according to the second embodiment of the invention;

FIG. 8 is a third schematic diagram showing the principle for queuing and scheduling according to the second embodiment of the invention; and

FIG. 9 is a flow chart of queuing and scheduling according to the second embodiment of the invention.

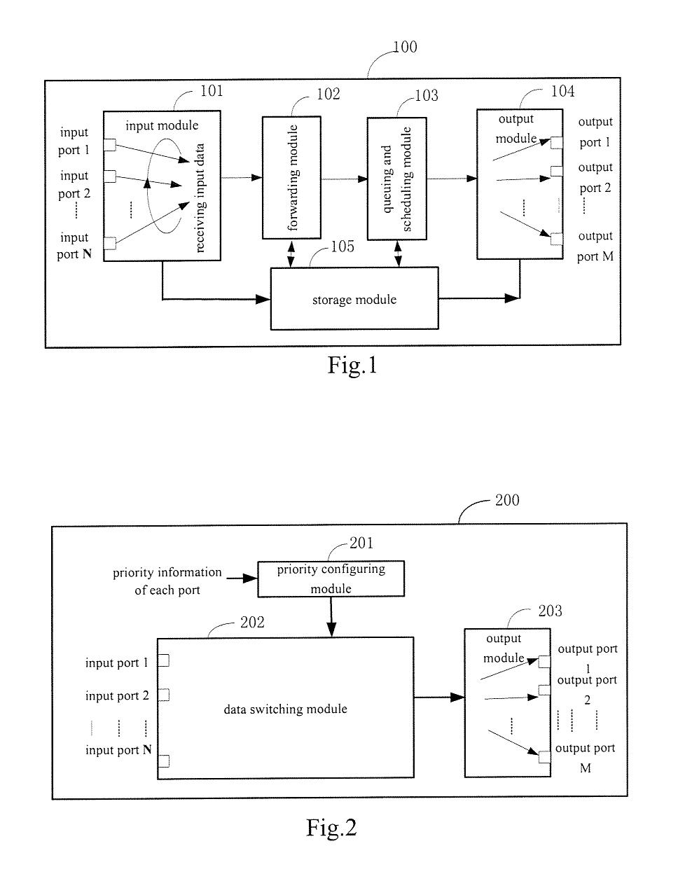

### DETAILED DESCRIPTION OF THE EMBODIMENTS

In the embodiments of the invention, a priority for all or some of the input ports or the input data in a network device or a system is configured, in order to distinguish the input ports or the input data by importance. During the data processing, for the precedence input ports or input data, network resources are preferentially allocated, and receiving, forwarding and scheduling, as well as outputting are preferentially performed, so as to ensure the processing rate and processing quality of the important precedence input ports or input data. After the processing for the precedence input ports or input data, other input data is processed in a normal mode.

In order to make the objects, technical solutions and advantages of the invention clearer, the invention is further described in detail in conjunction with drawings and embodiments. It should be appreciated that the embodiments described hereinafter are only used to explain the invention and are not intended to limit the invention.

FIG. 2 shows the structure of a network device 200 according to an embodiment of the invention. A priority configuring module 201 is adapted to configure a priority for each input port and send the priority configuration results. A data switching module 202 includes at least two input ports. At least one input port is configured with a priority. The data switching module 202 is connected with the priority configuring module 201 for receiving priority information, and performing data switching and sending for the input data from each input port according to the input port priority. An output module 203 includes at least one output port. The output module 203 is connected with the data switching module 202 and is adapted to output the data processed by the data switching module.

The data switching module 202 may further include: an input unit adapted to receive data from each input port; a forwarding unit adapted to analyze and classify the input data received by the input unit, so as to obtain the forwarding information; a queuing and scheduling unit adapted to perform queuing and scheduling for the forwarded input data according to the forwarding information and the priority, and send the scheduled data from a queue to the output module; and a storage unit, which may be connected with the input unit, the forwarding unit and the queuing and scheduling unit, and is adapted to store data and information.

FIG. 2 shows the logic structure of the network device 200 but not the physical position relationship between the modules. For example, the input ports and the output ports are generally positioned adjacent to each other; the input unit and the forwarding unit may be integrated into one module in practice; the storage unit in practice may be one unit or several units, or may be distributed in other modules or units, or may be in one chip together with other modules or units, or may be in a different chip.

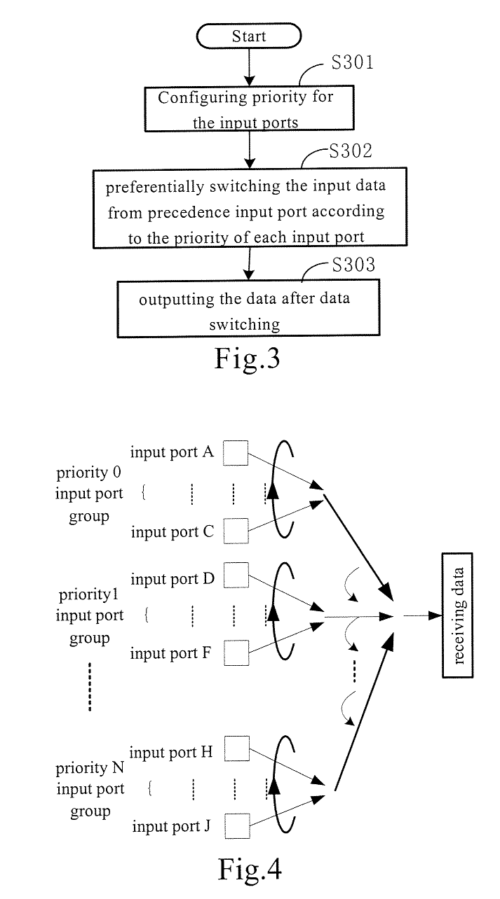

FIG. 3 shows the flow chart of data processing according to an embodiment of the invention, which will be described in detail as follows:

in a priority configuring step S301, a priority is configured for each input port;

in a data switching step S302, the input data from a precedence input port is preferentially processed according to the priority of the input port;

in an output step S303, the switched data is output.

The data switching step S302 may specifically include:

receiving input data from each input port according to the priority of the input port;

analyzing, classifying and forwarding the input data, and obtaining forwarding information; and

queuing and scheduling the forwarded input data according to the priority of the input port and the forwarding information, so as to obtain the network data from a scheduled queue, and then send the data to the output module.

One of the applications of the invention is that when the data switching module in a user broadband access device includes at least one WAN input port and at least one LAN input port, the priority configuring module configures a priority or a comparatively high priority for the WAN input port, but configures no priority or a low priority for the LAN input port. A control module controls the data switching module to preferentially process the data from the WAN input port with a priority or a comparatively high priority, so as to preferentially guarantee the traffic from the WAN port.

In addition to using the priority information for the allocation of the input receiving resources and queuing and scheduling resources, the priority information may also be used for the allocation of other network resources in a network system or a network device, such as receiving resources for input data, data processing (e.g. carrying out operations like data analysis, classification and table look-up) resources, queuing and scheduling resources, memory capacity and memory bandwidth resources, switching resources, queue management resources, forwarding and scheduling resources, output bandwidth resources, and output port resources, etc. After obtaining the priority by means of configuring priority for the input port or input data or by means that the input data carry the priority information with themselves, the processing rate and processing quality of important data in a network may be guaranteed by allocating network device resources such as port resources, bandwidth resources, forwarding resources, queuing and scheduling resources, and storage resources, etc., according to the priority,

### Embodiment 1

FIG. 4 shows the principle for receiving input data from at least one input port according to an embodiment of the invention.

The input ports are divided into a precedence input port group and a normal input port group, and a port group may contain only one port. There may be a configurable parameter or register in the system, which is adapted to define which port belongs to the precedence input port group (and define the precedence sequence among the precedence ports or define whether there is a sequence or not) and which belongs to the normal input port group. The priority of the port may also be indicated by its port number (for example, port 0 indicates the port with a highest priority). The system may have an enable parameter or a register for configuring whether the priority of the ports need to be differentiated.

When no port belongs to the precedence group or the function of differentiating the priority of the input port is not enabled, only the polling method is implemented by the input module, which is the same as the existing solution with respect to the function.

When the precedence input ports are configured for the system and such function is required, the input module firstly receives data from the precedence port group, until no data exists in any port of the precedence port group, then the input module receives data from the normal port group by the polling method. If there is only one precedence input port, then each time when it is ready for receiving data, the precedence input port is checked whether data exists: if yes, the data in the precedence port is received; otherwise, a nonempty port is chosen from the normal input port group by the polling method (according to the definition of polling, this port should be the next port to the one that has been chosen last time, and hereinafter by analogy) and then the data from the chosen port is received. If the precedence input port group includes a plurality of precedence input ports, and the priorities of these input ports are differentiated, then each time when it is ready for receiving data, the precedence input port group is firstly checked whether data exists: if yes, a nonempty port with the highest priority is chosen and the data from it is received; otherwise, a nonempty port is chosen from the normal input port group by the polling method and the data from it is received. If the precedence input port group includes a plurality of precedence input ports and the priorities of these input ports are not differentiated, then each time when it is ready for receiving data, the precedence input port group is firstly checked whether data exists: if yes, a nonempty port is chosen from them by the polling or sequential method and then the data from the chosen port is received; otherwise, a nonempty port is chosen from the normal input port group by the polling method and the data from the chosen port is received.

In the input module, the input port may also be chosen as follows for receiving data: allocating a bandwidth quota for each port, and choosing a nonempty port, of which the bandwidth quota is not exhausted, according to the quota values; or allocating a weight for each input port and choosing a nonempty port according to the weight values. The substance of allocating a bandwidth quota or a weight for each input port is to differentiate the important port from the unimportant one, namely, they are substantively different methods for configuring the priority for each input port. Other similar methods for configuring the priority should also be included in the protection scope claimed in the invention, although they are not illustrated one by one here.

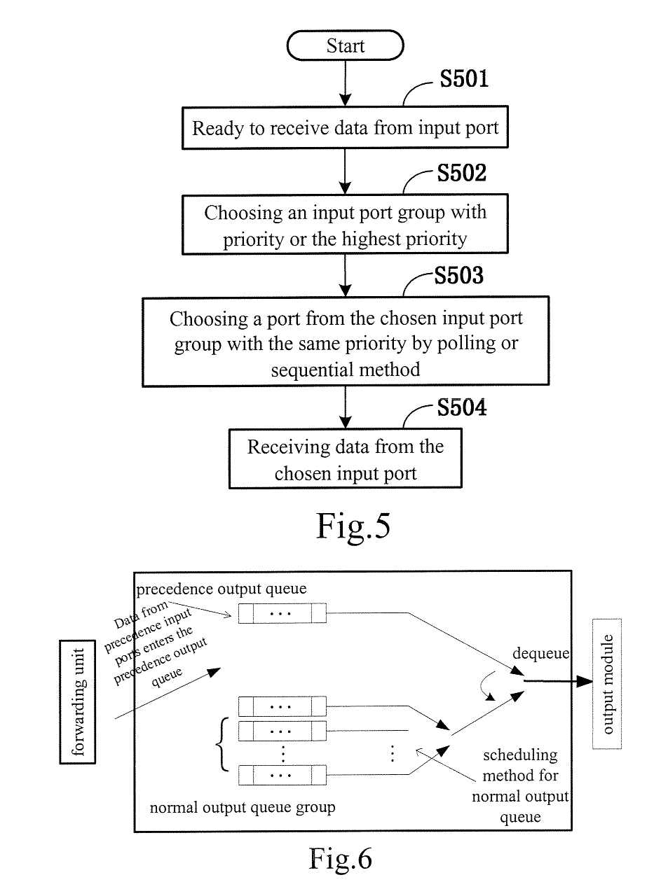

FIG. 5 is a flow chart showing the process for receiving the input data from the input port according to an embodiment of the invention, which will be described in detail as follows:

in step S501, it's ready for receiving input data from the input port;

in step S502, choosing an input port group with a priority or with the highest priority;

in step S503, choosing a nonempty port from the input port group with the highest priority by the polling or sequential method; and

in step S504, receiving the data from the chosen port.

### Embodiment 2

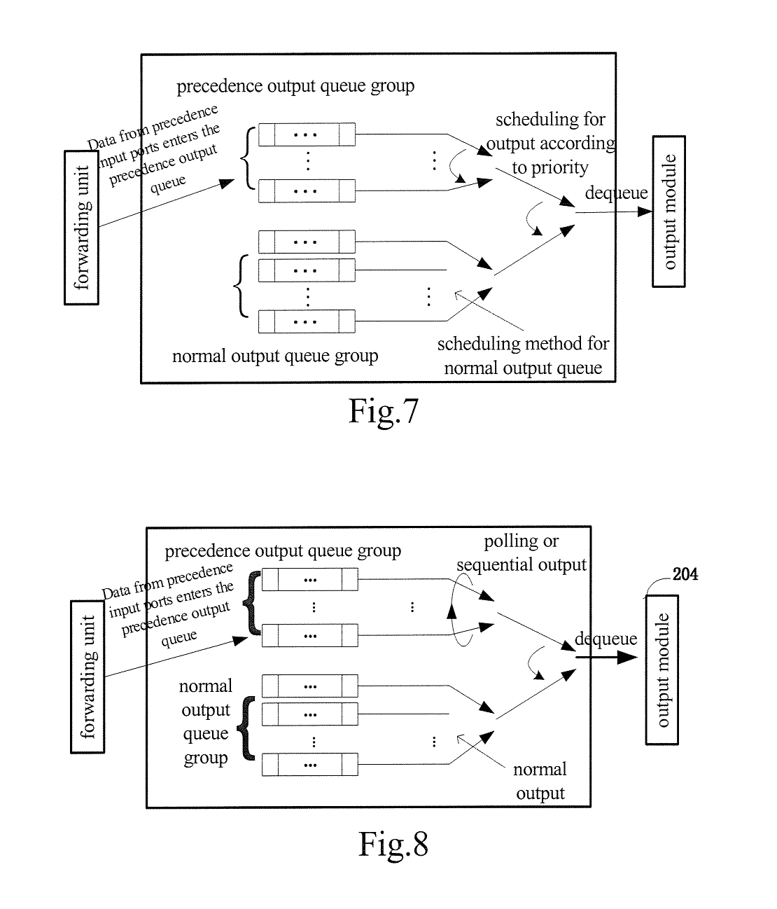

FIG. 6, FIG. 7 and FIG. 8 illustrate the principle for performing queuing and scheduling according to an embodiment of the invention.

In the queuing and scheduling unit, a precedence output queue group is added in addition to the existing normal output queue group, in order to make the data from the precedence input port or precedence input port group queue up. Each queue of the precedence output queue group may correspond to just one precedence input port, or may correspond to a plurality of precedence input ports, or may even correspond to all of the precedence input ports (at this point, the precedence output queue group includes only one precedence output queue). There may be a set of configurable parameters or registers (the settings from the input unit may also be re-used instead) for defining the data from which input port may queue in the precedence output queue (and for defining the precedence sequence of the precedence output queues or defining whether there is a sequence or not) and the data from which input port should queue in the normal queue for outputting in a normal way. In this way, it could be determined where data from an input port shall queue.

During queuing, the data from each precedence input port enters different precedence output queues according to the priority and the forwarding information of the forwarding unit, queues up and waits for being scheduled for output.

During scheduling for output, the data in the precedence output queue group is scheduled according to the priority firstly, until no data exists in any queue of the precedence output queue group, then the data from the normal queue group is scheduled with the existing method. If there is only one precedence output queue, as shown in FIG. 6, then each time when it is ready for scheduling data, the precedence output queue is firstly checked whether data exists: if yes, the data in the precedence output queue is scheduled. If the precedence output queue group includes a plurality of precedence output queues and the priorities of them is differentiated, as shown in FIG. 7, then each time when it is ready for scheduling data, a nonempty precedence output queue group with the highest priority is chosen. If the priority is not differentiated, or a plurality of queues, of which the priority is the same, have been chosen, as shown in FIG. 8, then one nonempty precedence output queue is chosen from the chosen queues by the polling or sequential method, and then the data thereof is scheduled and output.

When no queue belongs to the precedence group, or the function of differentiating the precedence output queues is not enabled, or no data exists in the precedence output queue group, the queuing and scheduling unit performs the scheduling method for the normal queues, which is the same as that in the prior art.

The queuing and scheduling unit may be replaced by other alternative solutions to realize the similar function. For example, when a precedence output queue group is to be added in addition to the existing normal output queue group, the data from the precedence input port may be made to queue up by way of adding a precedence output queue or queue group in correspondence with each input port. When scheduling is to be performed for each output port, the data in the precedence output queue group of the port is scheduled firstly according to the priority, until no data exists in any queue of the precedence output queue group. Then the data in the normal queue group of the port is scheduled as in the prior art. The other steps are the same as the method mentioned above and thus will not be described again here.

In the queuing and scheduling unit, each precedence output queue or the output queue corresponding to each output port may be divided into a plurality of sub-queues according to the data type. During scheduling for output, an appropriate sub-queue may be picked out according to data type, bandwidth quota or weight with the existing method.

In the queuing and scheduling unit, the queuing methods mentioned above may be adopted alone, for adding precedence output queue group for the precedence input ports, so that according to the priority and the forwarding information, the input data from each precedence input port enters the precedence output queue group and queues up, and the data in the precedence output queue group is firstly scheduled for output, and then the data in the normal output queue group is scheduled for output. When the data in the precedence output queues is to be dequeued, the priority among the precedence output queue groups as well as the priority among the precedence output queues may also not be differentiated, and the data is scheduled for output in a sequential or polling mode.

The different solutions mentioned above for realizing the queuing and scheduling unit may be implemented alone or in combination with each other, and it may be realized with hardware or software, or a combination thereof.

In a queuing and scheduling unit, the priority may also be configured between the precedence output queue group and the normal queue group, or among the queues in a precedence output queue group, by performing scheduling according to the preset bandwidth quota or weight.

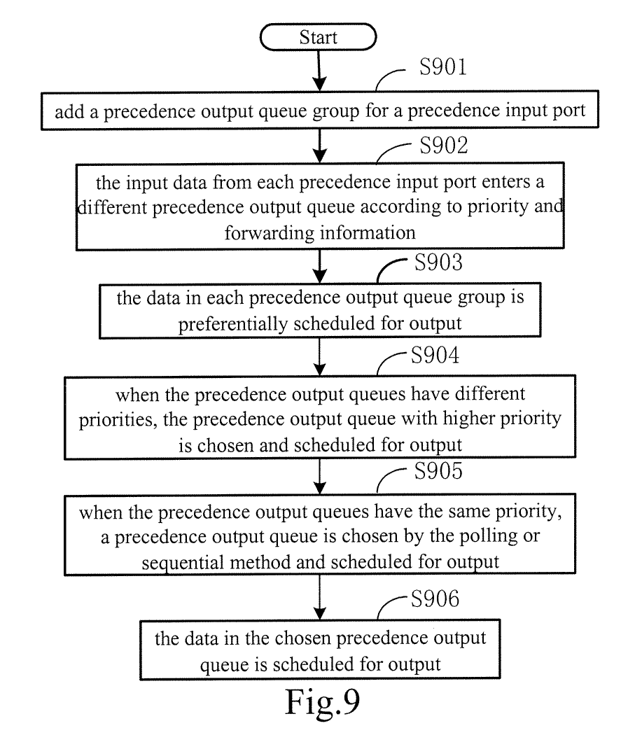

FIG. 9 is a flow chart showing the queuing and scheduling process according to an embodiment of the invention. Both the situation of precedence output queue groups having different priorities and the situation of precedence output queue groups having the same priority have been taken into consideration, which will be described in detail as follows:

in step S901, in addition to the existing normal output queue group, at least one precedence output queue group is added for a precedence input port;

in step S902, the input data from each precedence input port enters a different precedence output queue according to the priority and the forwarding information;

in step S903, during scheduling for output, the data in each precedence output queue group is preferentially scheduled for output, and then the data in the normal output queue group is scheduled for output;

in step S904, when the data in the precedence output queue group is scheduled for output, if the precedence output queues have different priorities, the nonempty precedence output queue with the highest priority is chosen firstly;

in step S905, when the data in the precedence output queue group is scheduled for output, if the precedence output queues have the same priority, a nonempty precedence output queue is chosen by the polling or sequential method; and

in step S906, the data in the chosen precedence output queue is scheduled for output.

The above embodiment 1 and embodiment 2 have made improvement on the input unit and the queuing and scheduling unit respectively, in view of the defects of the existing network devices in data processing flow. The two solutions are independent from each other and may be used alone or in combination with each other.

The methods and solutions of the invention may be carried out with hardware or software or a combination thereof.

When applied to broadband access devices, the corresponding embodiments of the invention overcome the defects in the prior art that the WAN port data is liable to suffer from delay, packet loss, output jam and so on due to the impact of the LAN port data. Because the connection or traffic of the WAN port is usually charged by the network carrier, the economic and effective utilization of the bandwidth of the WAN port may enhance the connect speed and efficiency for broadband users, and increase the client satisfaction for the services provided by network carriers.

Although the present invention has been described with the above embodiments, additional advantages and modifications will readily occur to those skilled in the art, without departing from the spirit or scope of the invention. The scope of the present invention should be defined by the appended claims and their equivalents.

What is claimed is:

1 A network device, comprising:
a data switching module having at least two input ports, wherein at least one of the input ports is configured with a priority, and the data switching module is adapted to perform data switching for input data from each input port according to the priority and send the data out; and
an output module, adapted to output the data processed by the data switching module.

2. The network device according to claim 1, wherein the data switching module comprises:
a first input unit, adapted to preferentially receive data from the input port with a priority when some of the input ports are configured with the priority; and
a second input unit, adapted to preferentially receive data from the input port with a higher priority when the input ports are configured with different priorities; and
a third input unit, adapted to receive data from the input ports with the same priority in a polling or sequential mode when each input port is configured with the same priority;
a forwarding unit, adapted to process the input data received by the first input unit, the second input unit and the third input unit, and obtain forwarding information of the input data;
a queuing and scheduling unit, adapted to configure an output queue group, enqueue processed input data in the output queue group, schedule the processed input data, and send the processed input data to the output module according to the forwarding information; and
a storage unit, adapted to store data and information, wherein the storage unit is connected with the first input unit, the second input unit, the third input unit, the forwarding unit and the queuing and scheduling unit.

3. The network device according to claim 1, wherein the data switching module comprises:
an input unit, adapted to receive input data from each input port;
a forwarding unit, adapted to process the input data received by the input unit, and obtain forwarding information of the input data;
a queuing and scheduling unit, adapted to configure a normal output queue group, enqueue processed input data in the normal output queue group, schedule the processed input data, and send the processed input data to the output module according to the forwarding information; and
a storage unit, adapted to store data and information, wherein the storage unit is connected with the input unit, the forwarding unit and the queuing and scheduling unit;
wherein the queuing and scheduling unit further comprises a first precedence queue sub-unit adapted to add a precedence output queue group, enqueue the data from a precedence input port in the precedence output queue group according to the forwarding information and the priority, and the data queuing in the precedence output queue group is preferentially scheduled for output.

4. The network device according to claim 1, wherein the data switching module comprises:
an input unit, adapted to receive input data from each input port;
a forwarding unit, adapted to process the input data received by the input unit, and obtain forwarding information of the input data;
a queuing and scheduling unit, adapted to configure a normal output queue group, enqueue processed input data in the normal output queue group, schedule the processed input data, and send the processed input data to the output module according to the forwarding information; and
a storage unit, adapted to store data and information, wherein the storage unit is connected with the input unit, the forwarding unit and the queuing and scheduling unit;
wherein the queuing and scheduling unit further comprises a second precedence queue sub-unit adapted to add a precedence output queue group for each output port, enqueue the data from a precedence input port in the precedence output queue group according to the forwarding information and the priority, and when data is to be output by each output port, the data queuing in the corresponding precedence output queue group is preferentially scheduled for output.

5. The network device according to claim 1, wherein the device further comprises a priority configuring module connected with the data switching module, and the priority configuring module is adapted to configure a priority or a comparatively high priority for an important input port, and configure no priority or a low priority for an unimportant input port.

6. A network access device, comprising:
a data switching module having at least one WAN input port and at least one LAN input port, wherein at least one input port is configured with a priority, and the data switching module is adapted to perform data switching for input data from each input port according to the priority, and preferentially process data from the WAN input port with a priority or a comparatively high priority, and send the processed data out; and
an output module adapted to output the data processed by the data switching module.

7. The network access device according to claim 6, wherein the device further comprises a priority configuring module connected with the data switching module, and the priority configuring module is adapted to configure a priority or a comparatively high priority for the WAN input port, and configure no priority or a low priority for the LAN input port.

8. A method for processing network data, comprising:
performing data switching preferentially for input data from a precedence input port according to a preset priority of at least one input port; and
outputting switched data.

9. The method according to claim 8, wherein performing data switching comprises:
obtaining input data from each input port according to priority information: when some of the input ports are configured with a priority, preferentially obtaining the data from the input port with the priority and then obtaining the data from the input port without priority; and when the input ports are configured with different priorities, preferentially obtaining the input data from the input port with a higher priority; and when all the input ports are configured with a same priority, obtaining the input data from the input ports with the same priority in a polling or sequential mode;
processing the input data and obtaining forwarding information of the input data; and
queuing and scheduling the processed input data according to the forwarding information, obtaining network data from a scheduled queue, and then sending out the network data.

10. The method according to claim 8, wherein performing data switching comprises:
obtaining input data from each input port;
processing the input data, and obtaining forwarding information; and
according to the forwarding information, enqueuing forwarded input data in a normal output queue group, and scheduling the forwarded input data for output in a polling or sequential mode and sending the data to an output module;
wherein, enqueuing forwarded input data in a normal output queue group, and scheduling the forwarded input data for output in a polling or sequential mode and sending the data to the output module comprises:
enqueuing the forwarded input data from the precedence input port in a precedence output queue group, and
scheduling and outputting the data queuing in the precedence output queue group preferentially.

11. The method according to claim 8, wherein performing data switching comprises:
obtaining input data from each input port;
processing the input data, and obtaining forwarding information of the input data; and
according to the forwarding information, enqueuing forwarded input data in a normal output queue group, and scheduling the forwarded input data for output in a polling or sequential mode and sending the data to the output module;
wherein, enqueuing forwarded input data in a normal output queue group, and scheduling the forwarded input data for output in a polling or sequential mode and sending the data to the output module comprises:
enqueuing the forwarded input data from the precedence input port in a precedence output queue group corresponding to an output port, and
preferentially scheduling the data in the corresponding precedence output queue group for output, when the data is to be output from each output port.

12. The method according to claim 8, wherein performing data switching comprises:
obtaining input data from each input port;
processing the input data, and obtaining forwarding information of the input data; and
according to the forwarding information, enqueuing forwarded input data in a output queue group, and scheduling the forwarded input data for output and sending the data to an output module;
wherein, enqueuing forwarded input data in a output queue group, and scheduling the forwarded input data for output and sending the data to the output module comprises:
preferentially queuing and scheduling the data from the input port with a priority when some input ports are configured with the priority; and
preferentially queuing and scheduling the data from the input port with a higher priority when the input ports are configured with different priorities; and
queuing and scheduling the data from the input ports with a same priority sequentially or by polling when all the input ports are configured with the same priority.

13. The method according to claim 8, wherein the method further comprises: configuring a priority or a comparatively high priority for an important input port, and configuring no priority or a low priority for an unimportant input port.

14. The method according to claim 13, wherein configuring a priority for the input port comprises one of: configuring the priority for the input port by means of setting an input-port serial number, setting a configurable priority register, configuring a weight for each input port, and allocating a bandwidth quota for each input port.

15. A method for allocating network resources in a network system, comprising:
determining a plan for allocation of all kinds of network resources according to a priority, and sending out priority control information; and
allocating all kinds of network resources according to the priority control information, so as to preferentially process input data with a priority or a high priority.

16. The method according to claim 15, wherein the network resources comprise resources for receiving input data, data processing resources, queue and scheduling resources, storage capacity and storage bandwidth resources, switching resources, queue management resources, forwarding and scheduling resources, output bandwidth resources, and output port resources.

17. The method according to claim 8, wherein performing data switching comprises:
obtaining input data from each input port according to priority information: when some of the input ports are configured with a priority, preferentially obtaining the data from the input port with the priority and then obtaining the data from the input port without priority;
processing the input data and obtaining forwarding information of the input data; and
queuing and scheduling the processed input data according to the forwarding information, obtaining network data from a scheduled queue, and then sending out the network data.

18. The method according to claim 8, wherein performing data switching comprises:
obtaining input data from each input port according to priority information: when the input ports are configured with different priorities, preferentially obtaining the input data from the input port with a higher priority;
processing the input data and obtaining forwarding information of the input data; and
queuing and scheduling the processed input data according to the forwarding information, obtaining network data from a scheduled queue, and then sending out the network data.

19. The method according to claim 8, wherein performing data switching comprises:
obtaining input data from each input port according to priority information: when all the input ports are configured with a same priority, polling to receive or sequentially obtaining the input data from the input ports with the same priority;
processing the input data and obtaining forwarding information of the input data; and
queuing and scheduling the processed input data according to the forwarding information, obtaining network data from a scheduled queue, and then sending out the network data.

20. A system for a network, the system comprising:
one or more components for processing a request, the one or more components are configured to:
performing data switching preferentially for input data from a precedence input port according to a preset priority of at least one input port; and
outputting switched data.
